(19) United States
(12) Patent Application Publication
(10) Pub. No.: US 2026/0299324 A1
(43) Pub. Date: Oct. 1, 2026

(54) INTEGRATED PHOTONIC ISOLATOR

(71) Applicant: Lightmatter, Inc., Boston, MA (US)

(72) Inventors: Nikhil Kumar, East Palo Alto, CA (US); Srinivasan Ashwyn Srinivasan, Toronto (CA)

(73) Assignee: Lightmatter, Inc., Boston, MA (US)

(21) Appl. No.: 19/397,815

(22) Filed: Nov. 21, 2025

Related U.S. Application Data
(60) Provisional application No. 63/781,812, filed on Apr. 1, 2025.

(51) Int. Cl. G02F 1/01; G02F 1/21; G02F 1/225

(52) U.S. Cl. CPC G02F 1/0136; G02F 1/212; G02F 1/225

(57) ABSTRACT

Described herein are photonic isolators that utilize integrated photonic polarization controllers to block (or at least attenuate) back-reflections. A photonic isolator includes a first polarization controller formed on a first photonic integrated circuit (PIC) and a second polarization controller formed on a second PIC. The photonic isolator is arranged to permit passage of light in one direction (e.g., from a transmitting PIC to a receiving PIC) while blocking or at least attenuating passage of light in the opposite direction (e.g., from the receiving PIC to the transmitting PIC). The isolator described herein may be compatible with standard semiconductor fabrication processes, such as complementary metal-oxide-semiconductor (CMOS) processes, which provide scalability and high-volume manufacturing. Accordingly, some embodiments relate to an integrated photonic isolator that can be manufactured using CMOS fabrication techniques without the use of exotic magnetic materials.

### CROSS-REFERENCE TO RELATED APPLICATIONS

This application claims the benefit under 35 U.S.C. § 119(e) of U.S. Provisional Application Ser. No. 63/781,812, filed on Apr. 1, 2025, under Attorney Docket No. L0858.70123US00 and entitled “INTEGRATED PHOTONIC ISOLATOR,” which is hereby incorporated herein by reference in its entirety.

### BACKGROUND

Back reflections from optical components in an optical system can return to the optical source (e.g., laser) and disrupt its operation. Photonic isolators are used to prevent unwanted reflections. Isolators are essentially one-way valves that allow light to pass through in one direction while blocking light traveling in the reverse direction.

Conventional photonic isolators rely on the Faraday effect, which involves the use of magneto-optical materials. These materials rotate the polarization of light in a magnetic field, and this rotation is non-reciprocal, meaning it occurs in one direction only. By carefully manipulating the polarization, an isolator can be constructed to block reflected light.

### BRIEF SUMMARY

In some aspects, the techniques described herein relate to a photonic system, including: a first polarization controller formed on a first photonic integrated circuit (PIC), the first polarization controller including a first detector; a second polarization controller formed on a second PIC, the second polarization controller including a second detector; a unidirectional optical channel coupling the first polarization controller to the second polarization controller; and a controller configured to control the first and second polarization controllers using a first signal provided by the first detector and a second signal provided by the second detector.

In some aspects, the techniques described herein relate to a photonic system, wherein the first PIC includes a laser configured to generate light and photonic circuitry configured to convey the light to the second PIC through the unidirectional optical channel.

In some aspects, the techniques described herein relate to a photonic system, wherein the first polarization controller includes a first phase shifter and a first interferometer including a second phase shifter, wherein controlling the first polarization controller includes controlling the first phase shifter and the second phase shifter.

In some aspects, the techniques described herein relate to a photonic system, wherein the second polarization controller includes a third phase shifter and a second interferometer including a fourth phase shifter, wherein controlling the second polarization controller includes controlling the third phase shifter and the fourth phase shifter.

In some aspects, the techniques described herein relate to a photonic system, wherein the first interferometer includes a Mach Zehnder interferometer (MZI) having at least one stage, and wherein the first detector is coupled to a port of the MZI.

In some aspects, the techniques described herein relate to a photonic system, wherein the first polarization controller further includes a polarization splitter and rotator coupled between the first phase shifter and the unidirectional optical channel.

In some aspects, the techniques described herein relate to a photonic system, further including photonic circuitry formed on the first PIC and configured to convey light to the second PIC through the unidirectional optical channel, wherein controlling the first and second polarization controllers includes controlling the first and second polarization controllers to maximize the first signal.

In some aspects, the techniques described herein relate to a photonic system, wherein controlling the first and second polarization controllers further includes controlling the first and second polarization controllers to minimize the second signal.

In some aspects, the techniques described herein relate to a photonic system, wherein the first polarization controller includes a first phase shifter and the second polarization controller includes a second phase shifter, wherein controlling the first polarization controller includes controlling the first phase shifter and controlling the second polarization controller includes controlling the second phase shifter.

In some aspects, the techniques described herein relate to a photonic system, further including photonic circuitry formed on the first PIC and configured to convey light to the second PIC through the unidirectional optical channel, wherein controlling the first and second polarization controllers includes controlling the first and second phase shifters to maximize the first signal.

In some aspects, the techniques described herein relate to a photonic system, wherein controlling the first and second polarization controllers further includes controlling the first and second phase shifters to minimize the second signal.

In some aspects, the techniques described herein relate to a photonic system, further including a substrate, wherein the first and second PICs are disposed on the substrate.

In some aspects, the techniques described herein relate to a photonic system, including: a laser; a first polarization controller coupled to the laser, the first polarization controller including: a first phase shifter; a Mach Zehnder interferometer (MZI), coupled to the first phase shifter, including a second phase shifter; and a first detector coupled to the first MZI; a unidirectional optical channel coupled to the first polarization controller; a second polarization controller coupled to the unidirectional optical channel, the second polarization controller including: a third phase shifter; a second MZI, coupled to the third phase shifter, including a fourth phase shifter; and a second detector coupled to the second MZI; and a controller configured to control the first, second, third and fourth phase shifters using a first signal provided by the first detector and a second signal provided by the second detector.

In some aspects, the techniques described herein relate to a photonic system, further including a substrate, a first photonic integrated circuit (PIC) and a second PIC, wherein: the laser, the first PIC and the second PIC are disposed on the substrate, and the first PIC includes the first polarization controller and the second PIC includes the second polarization controller.

In some aspects, the techniques described herein relate to a photonic system, wherein controlling the first, second, third and fourth phase shifters using the first and second signals includes controlling the first, second, third and fourth phase shifters to maximize the first signal.

In some aspects, the techniques described herein relate to a photonic system, wherein controlling the first, second, third and fourth phase shifters using the first and second signals further includes controlling the first, second, third and fourth phase shifters to minimize the second signal.

In some aspects, the techniques described herein relate to a method for controlling a photonic system, including: controlling photonic circuitry formed on a first photonic integrated circuit (PIC) to convey light to a second PIC through a unidirectional optical channel coupling the first PIC to the second PIC; and controlling a first polarization controller, formed on the first PIC, and a second polarization controller, formed on the second PIC, using a first signal provided by a first detector, formed on the first PIC, and a second signal provided by a second detector, formed on the second PIC.

In some aspects, the techniques described herein relate to a method, wherein: the first polarization controller includes a first phase shifter and a first interferometer including a second phase shifter, and the second polarization controller includes a third phase shifter and a second interferometer including a fourth phase shifter, controlling the first polarization controller includes controlling the first phase shifter and the second phase shifter, and controlling the second polarization controller includes controlling the third phase shifter and the fourth phase shifter.

In some aspects, the techniques described herein relate to a method, wherein controlling the first, second, third and fourth phase shifters includes controlling the first, second, third and fourth phase shifters to maximize the first signal.

In some aspects, the techniques described herein relate to a method, wherein controlling the first, second, third and fourth phase shifters includes controlling the first, second, third and fourth phase shifters to minimize the second signal.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a block diagram illustrating a photonic system including first and second photonic integrated circuits (PICs) coupled to each other by a unidirectional optical channel, and a photonic isolator formed in part on the first PIC and in part on the second PIC, in accordance with some embodiments.

FIG. 2A is a block diagram illustrating the first PIC of FIG. 1 in additional detail, in accordance with some embodiments.

FIG. 2B is a block diagram illustrating the second PIC of FIG. 1 in additional detail, in accordance with some embodiments.

FIG. 2C is a block diagram illustrating a controller coupled to the first and second PICs of FIG. 1, in accordance with some embodiments.

FIG. 3A is a plot illustrating the phases of optical signals traveling through the polarization controllers of FIG. 1, in accordance with some embodiments.

FIG. 3B is a plot illustrating the intensities of optical signals traveling through the ports of the polarization controllers of FIG. 1, in accordance with some embodiments.

### DETAILED DESCRIPTION

The directionality provided by photonic isolators is essential for maintaining signal integrity and preventing damage to sensitive optical sources, such as lasers. The inventors have recognized and appreciated, however, that conventional photonic isolators are often bulky and costly. Further, some conventional isolators are challenging to integrate into photonic integrated circuits (PICs) because they rely on exotic materials, including for example Terbium Gallium Garnet and Yttrium Iron Garnet. These materials, generally identified as magneto-optic materials, produce optical isolation through a mechanism referred to as Faraday rotation. While offering high levels of optical isolation, these materials are generally not compatible with standard semiconductor fabrication processes.

The inventors have further recognized and appreciated that recent advancements in integrated photonics have made it possible to manufacture on-chip optical isolators. Rather than using exotic magnetic-optic materials, various optical phenomena, such as non-reciprocal phase shifts and asymmetric mode conversion can be used to achieve isolation. Integrated photonic isolators according to some embodiments offer the advantages of smaller size, lower cost, and easier integration with other photonic components. For example, the isolators described herein may be compatible with standard semiconductor fabrication processes, such as complementary metal-oxide-semiconductor (CMOS) processes, which provide scalability and high-volume manufacturing. Accordingly, some embodiments relate to an integrated photonic isolator that can be manufactured using CMOS fabrication techniques without the use of exotic magnetic materials.

Some embodiments utilize integrated photonic polarization controllers to block (or at least attenuate) back-reflections. For example, a photonic isolator may include a first polarization controller formed on a first photonic integrated circuit (PIC) and a second polarization controller formed on a second PIC. The photonic isolator is arranged to permit passage of light in one direction (e.g., from a transmitting PIC to a receiving PIC) while blocking or at least attenuating passage of light in the opposite direction (e.g., from the receiving PIC to the transmitting PIC). As such, the optical channel coupling the first PIC to the second PIC is referred to as a unidirectional photonic channel. The word “unidirectional” indicates that the roles of the PICs may not be interchanged. The transmitting PIC is not supposed to operate as a receiver with respect to the optical channel; the receiving PIC is not supposed to operate as a transmitter with respect to the optical channel. As an example, the transmitting PIC may include a laser, and the receiving PIC may include photonic circuitry configured to process the light provided by the transmitting PIC. The photonic isolator protects the laser against back-reflections that may otherwise negatively affect its operations, or worse, cause permanent damage to it. In this example, the role of the laser as the transmitting PIC should not be interchanged with the role of photonic circuitry as the receiving PIC—thus making the optical channel a unidirectional optical channel.

A first polarization controller formed on the transmitting PIC may be coupled to the laser and a second polarization controller formed on the receiving PIC may be coupled to the photonic circuitry. Thus, the polarization controllers are positioned on opposite ends of the unidirectional optical channel. The response of each polarization controller may be adjusted by adjusting the amount of phase shift provided by a bank of phase shifters. In each polarization controller, a first phase shifter is formed inside an interferometer to vary the relative phase between the arms of the interferometer and a second phase shifter is formed outside the interferometer. A controller controls the phase shifters of both polarization controllers based on signals provided by a pair of detectors—one detector is coupled to the transmitting polarization controller and the other detector is coupled to the receiving polarization controller. The first detector may be coupled to a port of the interferometer that is π/2-phase shifted relative to the port to which the laser is coupled. Similarly, the second detector may be coupled to a port of the interferometer that is π/2-phase shifted relative to the port to which the receiving photonic circuitry is coupled. In some embodiments, blocking back-reflections may involve adjusting the amount of phase shift provided by the phase shifters until the signal produced by the first detector is maximized and the signal produced by the second detector is minimized. This ensures that the amount of optical power reflected back into the laser is minimized and the amount of optical power transmitted to the receiving photonic circuitry is maximized.

It should be appreciated that photonic isolators of the types described herein are not limited to use with lasers, but may be used in any context in which it is desirable to block back-reflections. For example, the transmitting PIC may include transmit circuitry, optical processing circuitry, optical amplification circuitry, etc. Some embodiments include multiple PICs and an integrated photonic isolator may be included on one or more of the multiple PICS (e.g., all of them). Embodiments described below focus on two PICs, but isolators may be formed from any number of PICs.

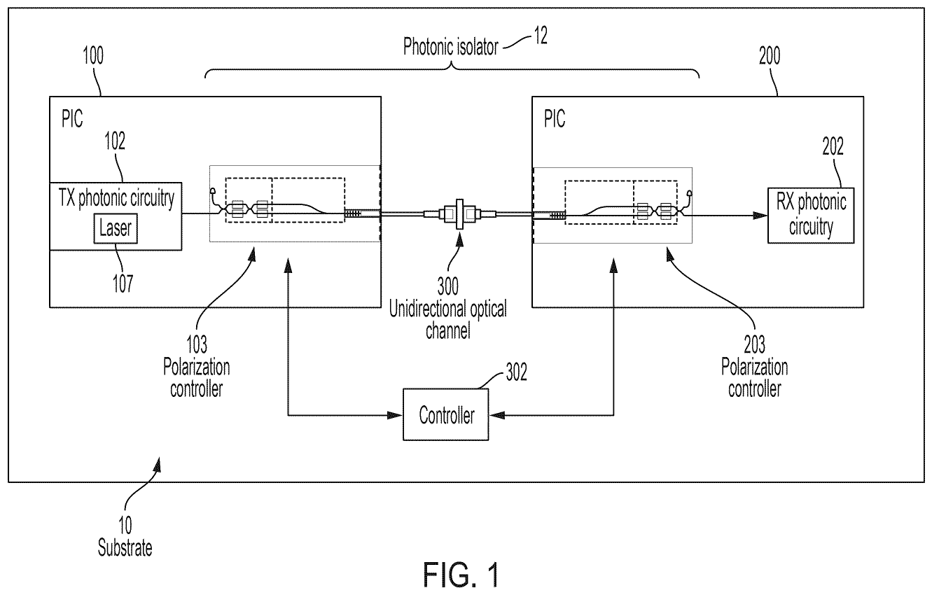

FIG. 1 is a block diagram illustrating a photonic system including a first PIC 100 and a second PIC 200. The PICs are coupled to each other by a unidirectional optical channel 300. A photonic isolator 12 is formed in part on PIC 100 and in part on PIC 200. Unidirectional optical channel 300 may be implemented using one or more single mode fibers (SMFs). However, other types of optical channels may be used, including for example polarization maintaining fibers, free space media or integrated photonic waveguides. In some embodiments, PIC 100 and PIC 200 are disposed on a common substrate—substrate 10. Substrate 10 may include a printed circuit board, an interposer, an organic substrate or any other suitable support.

PIC 100 operates as the transmitting PIC and PIC 200 operates as the receiving PIC. As discussed above, the role of PIC 100 as the transmitting PIC should not be interchanged with the role of PIC 200 as the receiving PIC—thus making the optical channel 300 a unidirectional optical channel. PIC 100 includes transmitting (TX) photonic circuitry 102 and a polarization controller 103. TX photonic circuitry 102 may include photonic components configured to convey light from PIC 100 to PIC 200, including for example an optical coupler and/or an optical multiplexer that multiplexes wavelength division multiplexing (WDM) channels on a common waveguide. Optionally, TX photonic circuitry 102 may include a laser 107, which may be configured to emit light at a single carrier wavelength or, to support WDM communication, multiple carrier wavelengths. Similarly, PIC 200 includes receiving (RX) photonic circuitry 202 and a polarization controller 203. RX photonic circuitry 202 may include photonic components configured to receive light conveyed from PIC 100, including for example an optical coupler and/or an optical demultiplexer that demultiplexes the transmitted WDM channels and/or an optical modulation unit configured to impart data on the light.

Polarization controller 103 and polarization controller 203 form part of photonic isolator 12. A controller 302 controls the operations of polarization controller 103 and polarization controller 203. Controller 302 may be implemented using any suitable logic circuitry capable of executing methods as described herein. For example, controller 302 may comprise one or more central processing units (CPUs), one or more graphics processing units (GPUs), one or more digital signal processors (DSPs), one or more field-programmable gate arrays (FPGAs), one or more application-specific integrated circuits (ASICs), or one or more microcontrollers. In some embodiments, controller 302 may include a combination of two or more of the foregoing components. These components may be interconnected locally (e.g., via a system bus or local interconnect), over a local area network (LAN), or via a cloud-based architecture, depending on system configuration and application requirements. Additionally, controller 302 may include one or more analog-to-digital converters (ADCs) and one or more digital-to-analog converters (DACs) to facilitate signal conversion between analog and digital domains. In some embodiments, controller 302 may be disposed on substrate 10.

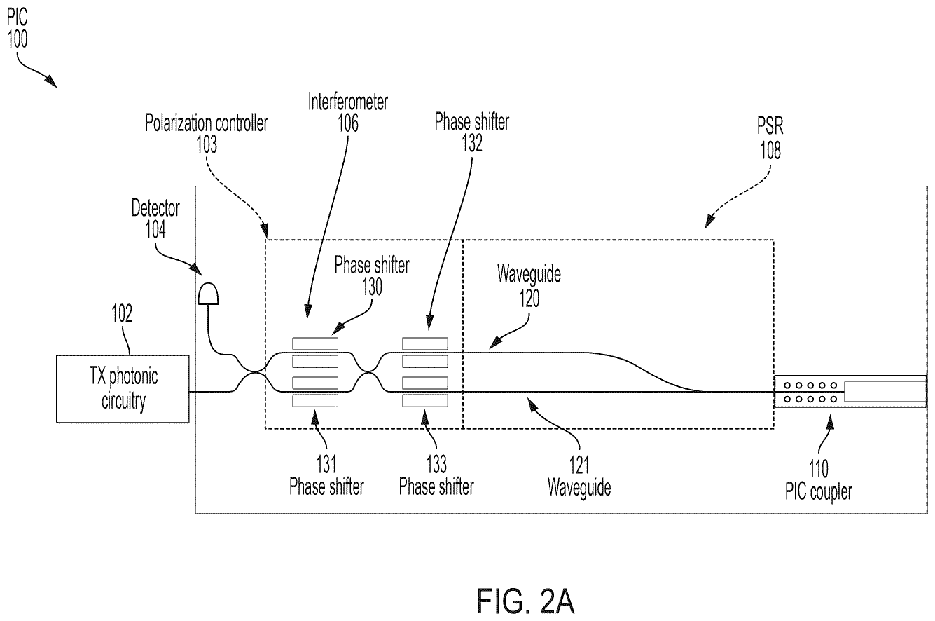

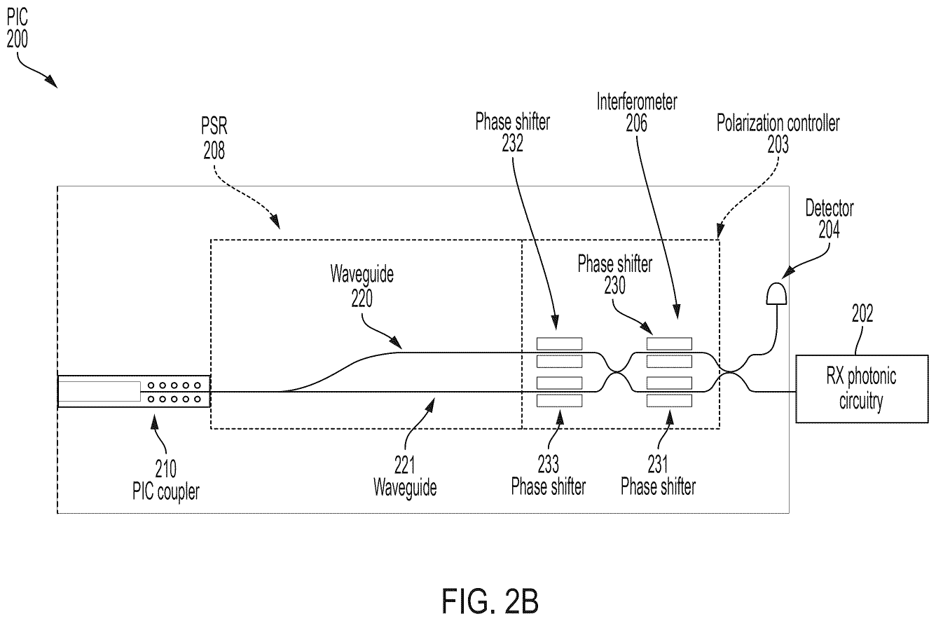

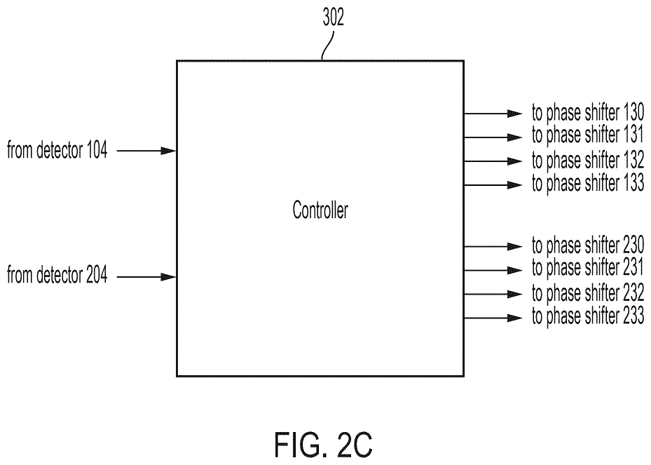

FIG. 2A is a block diagram illustrating PIC 100 in additional detail, in accordance with some embodiments. As described in connection with FIG. 1, PIC 100 includes TX photonic circuitry 102 and polarization controller 103. In addition, PIC 100 includes polarization splitter and rotator (PSR) 108, detector 104 and PIC coupler 110.

Polarization controller 103 includes interferometer 106 and phase shifters 130, 131, 132 and 133. Interferometer 106 may be implemented as a Mach Zehnder interferometer (MZI) in some embodiments. As such, interferometer 106 may include a pair of opposing arms coupled between a pair of 2×2 optical couplers. The MZI of FIG. 2A is a one-stage MZI (comprising an input splitter, two arms and an output combiner). However, interferometer 106 may be implemented as a multi-stage MZI in some embodiments (comprising two or more cascaded interference stages), such as a two-stage MZI, a three-stage MZI, a four-stage MZI, etc.

Phase shifters 130, 131, 132 and 133 may be implemented using any suitable mechanism, including the thermo-optic effect or the electro-optic effect. For example, the phase shifters may include heaters—when electric current flows through them, the local temperature increases, thereby causing a local change in refractive index. Phase shifters 130 and 131 are positioned inside interferometer 106 while phase shifters 132 and 133 are positioned outside interferometer 106. Phase shifter 130 is configured to adjust the phase of the optical signal traveling along the upper arm of interferometer 106 and phase shifter 131 is configured to adjust the phase of the optical signal traveling along the lower arm of interferometer 106. Collectively, phase shifters 130 and 131 operate to vary the relative phase difference between the optical signal traveling along the upper arm and the optical signal traveling along the lower arm. To that end, one of the phase shifters may be omitted, and a single phase shifter may be used to vary the relative phase shift between the arms.

Similarly, phase shifter 132 is configured to adjust the phase of the optical signal traveling along waveguide 120 and phase shifter 133 is configured to adjust the phase of the optical signal traveling along waveguide 121. Collectively, phase shifters 132 and 133 operate to vary the relative phase difference between the optical signal traveling along waveguides 120 and 121. To that end, one of the phase shifters may be omitted.

Detector 104 is connected to a port of interferometer 106 that is π/2-phase shifted relative to the port to which TX photonic circuitry 102. As a result, maximizing the signal produced by detector 104 results in the minimization of the optical power back-reflected into TX photonic circuitry 102. Detector 104 is a device that converts light received from interferometer 106 into a signal in the electronic domain. Detector 104 may be implemented as a photodetector (e.g., a photodiode).

PSR 108 connects to waveguides 120 and 121, and is configured to combine the optical signals present on waveguides 120 and 121 into an optical signal having a polarization suitable for transmission through unidirectional optical channel 300. In some embodiments, PSR 108 is configured to provide polarization splitting and rotation. PIC coupler 110 couples light from PIC 100 to unidirectional optical channel 300, and may be implemented as an on-chip edge coupler or an on-chip out-of-plane coupler (e.g., a grating coupler).

FIG. 2B is a block diagram illustrating PIC 200 in additional detail, in accordance with some embodiments. As described in connection with FIG. 1, PIC 200 includes RX photonic circuitry 202 and polarization controller 203. In addition, PIC 200 includes PSR 208, detector 204 and PIC coupler 210.

Similar to polarization controller 103, polarization controller 203 includes interferometer 206 and phase shifters 230, 231, 232 and 233 (which may be implemented in the same manner as phase shifters 130, 131, 132 and 133). Interferometer 206 may be implemented as an MZI in some embodiments (whether a one-stage as shown, or a multi-stage MZI), and may include a pair of opposing arms coupled between a pair of 2×2 optical couplers. Phase shifters 230 and 231 are positioned inside interferometer 206 while phase shifters 232 and 233 are positioned outside interferometer 206. Phase shifter 230 is configured to adjust the phase of the optical signal traveling along the upper arm of interferometer 206 and phase shifter 231 is configured to adjust the phase of the optical signal traveling along the lower arm of interferometer 206. Collectively, phase shifters 230 and 231 operate to vary the relative phase difference between the optical signal traveling along the upper arm and the optical signal traveling along the lower arm. To that end, one of the phase shifters may be omitted. Similarly, phase shifter 232 is configured to adjust the phase of the optical signal traveling along waveguide 220 and phase shifter 233 is configured to adjust the phase of the optical signal traveling along waveguide 221. Collectively, phase shifters 230 and 231 operate to vary the relative phase difference between the optical signal traveling along waveguides 220 and 221. To that end, one of the phase shifters may be omitted.

Detector 204 is connected to a port of interferometer 206 that is z/2-phase shifted relative to the port to which RX photonic circuitry 202. As a result, minimizing the signal produced by detector 204 results in the maximization of the optical power transferred to RX photonic circuitry 202. Detector 204 may be implemented in the same manner as detector 104.

PIC coupler 210 couples light from unidirectional optical channel 300 to PIC 200, and may be implemented in the same manner as PIC coupler 110. PSR 208 connects to waveguides 220 and 221, and is configured to provide polarization splitting and rotation. Light coupled to PIC 200 from unidirectional optical channel 300 may have arbitrary polarization, especially in those embodiments in which unidirectional optical channel 300 is implemented as a non-polarization maintaining fiber. To ensure proper operation of PIC 200 despite the arbitrary polarization, PSR separates the incoming light into an optical signal having transverse electric (TE) polarization and an optical signal having transverse magnetic (TM) polarization. The TE component is conveyed to waveguide 221 and the TM component is conveyed to waveguide 220. Waveguide 220 may include a polarization rotator configured to rotate the polarization of the optical signal, thereby converting the TM component into another TE component. The result is that both waveguides support TE-polarized light as the light transitions into interferometer 206.

As discussed above, a controller 302 controls the operations of polarization controller 103 and polarization controller 203. FIG. 2C is a block diagram illustrating the inputs and outputs of controller 302, in accordance with some embodiments. As shown, controller 302 receives the signals produced by detectors 104 and 204 as inputs. It should be noted that the signals produced by detectors 104 and 204 may represent the photocurrents produced by the detectors 104 and 204 or signals derived from those photocurrents (e.g., upon passage through a trans-impedance amplifier or other electronic circuitry). Using the signals received from detectors 104 and 204, controller 302 generates a set of control signals intended to control phase shifters 130, 131, 132, 133, 230, 231, 232 and 233. As noted above, given the differential nature of the phase shifts to be imparted on the PICS, half of the phase shifters may be omitted in some embodiments. As such, controller 302 may generate four control signals (instead of eight).

Controller 302 may be programmed to block (or at least attenuate) optical reflections back to TX photonic circuity 102 while promoting optical transmission to RX photonic circuitry 202. For example, controller 302 may be optimized to minimize optical reflections back to TX photonic circuity 102 while maximizing optical transmission to RX photonic circuitry 202. In some embodiments, controller 302 can use the signal generated by detector 104 as a proxy for the amount of optical power reflected back to TX photonic circuity 102. This is because the optical signal traveling through the port of interferometer 106 coupled to detector 104 is π/2-phase shifted relative to the optical signal traveling through the port to which TX photonic circuitry 102 is coupled. In maximizing the amount of optical power received by detector 104, the amount of optical power reflected back to TX photonic circuitry 102 is minimized. Similarly, controller 302 can use the signal generated by detector 204 as a proxy for the amount of optical power transmitted through RX photonic circuity 202. This is because the optical signal traveling through the port of interferometer 206 coupled to detector 204 is π/2-phase shifted relative to the optical signal traveling through the port to which RX photonic circuitry 202 is coupled. In minimizing the amount of optical power received by detector 204, the amount of optical power transmitted to RX photonic circuitry 202 is maximized.

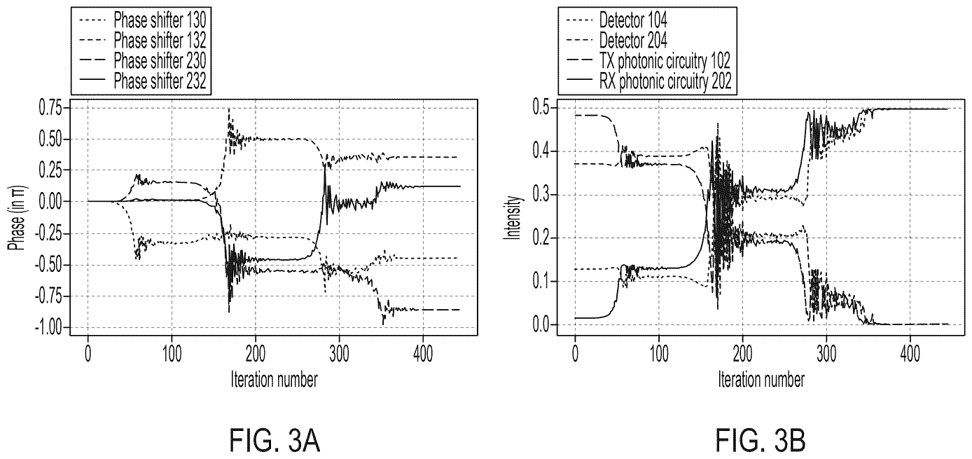

Controller 302 controls the amount of optical power received by detectors 104 and 204 by controlling the amount of phase shift imparted by the phase shifters using a feedback loop. The operations of controller 302 are described in connection with FIGS. 3A-3B, in accordance with one example. In the example of FIGS. 3A-3B, it will be assumed that half of the phase shifters of FIGS. 2A-2B are omitted, and that controller 302 generates four control signals. For example, phase shifters 131, 133, 231 and 233 may be omitted. Controller 302 controls phase shifter 130 to impart a phase difference between the arms of interferometer 106 and controls phase shifter 230 to impart a phase difference between the arms of interferometer 206. Similarly, controller 302 controls phase shifter 132 to impart a phase difference between waveguide 120 and waveguide 121, and controls phase shifter 232 to impart a phase difference between waveguide 220 and waveguide 221.

FIG. 3A is a plot illustrating the amount of phase shift imparted by phase shifters 130, 132, 230 and 232 as a function of the iteration number. The amount of phase shift is expressed in radians (π). The iteration number represents the iterations through which controller 302 goes in controlling the phase shifters to block (or at least attenuate) back-reflections while promoting optical transmission to RX photonic circuitry 202. Each iteration number represents a step of this iterative process. Correspondingly, FIG. 3B is a plot illustrating the relative optical power level, as a function of the iteration number, of the following optical signals: 1) optical signal incident on detector 104 (labelled “Detector 104”), 2) optical signal incident on detector 204 (labelled “Detector 204”), 3) optical signal back-reflected to TX photonic circuitry 102 (labelled “TX photonic circuitry 102”) and 4) optical signal transmitted to RX photonic circuitry 202 (labelled “RX photonic circuitry 202”). The power levels shown in FIG. 3B are normalized—the sum of all the power levels of FIG. 3B equals 1.

Initially (iteration number =0), controller 302 controls all the phase shifters to impart a phase shift equal to 0. In this example, this results in the normalized power level at detector 104 being about 0.12, the normalized power level at detector 204 being about 0.38, the normalized power level at RX photonic circuitry 202 being about 0.02 and the normalized power level at TX photonic circuitry 102 being about 0.48. Subsequently, controller 302 begins to iterate by altering the amount of phase shift imparted by each phase shifter. As a result, the normalized power levels vary relative to the initial values. The process ultimately converges at or about iteration 350. Subsequently, the phase shift imparted by phase shifter 130 is about −0.45π, the phase shift imparted by phase shifter 132 is about 0.35π, the phase shift imparted by phase shifter 230 is about −0.85z and the phase shift imparted by phase shifter 232 is about 0.13π.

Correspondingly, the normalized power level at detector 104 is about 0.5, the normalized power level at detector 204 is about 0, the normalized power level at RX photonic circuitry 202 is about 0.5 and the normalized power level at TX photonic circuitry 102 is about 0. As such, the back-reflected optical power is minimized and the optical power transmitted to RX photonic circuitry 202 is maximized, thus yielding a high degree of optical isolation.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the technology described herein may be used alone, in combination, or in a variety of arrangements not specifically described in the embodiments described in the foregoing and is therefore not limited in its application to the details and arrangement of modules set forth in the foregoing description or illustrated in the drawings. For example, aspects described in one embodiment may be combined in any manner with aspects described in other embodiments.

Also, the technology described herein may be embodied as a method, of which examples are provided herein. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A photonic system, comprising:
a first polarization controller formed on a first photonic integrated circuit (PIC), the first polarization controller comprising a first detector;
a second polarization controller formed on a second PIC, the second polarization controller comprising a second detector;
a unidirectional optical channel coupling the first polarization controller to the second polarization controller; and
a controller configured to control the first and second polarization controllers using a first signal provided by the first detector and a second signal provided by the second detector.

2. The photonic system of claim 1, wherein the first PIC comprises a laser configured to generate light and photonic circuitry configured to convey the light to the second PIC through the unidirectional optical channel.

3. The photonic system of claim 1, wherein the first polarization controller comprises a first phase shifter and a first interferometer comprising a second phase shifter, wherein controlling the first polarization controller comprises controlling the first phase shifter and the second phase shifter.

4. The photonic system of claim 3, wherein the second polarization controller comprises a third phase shifter and a second interferometer comprising a fourth phase shifter, wherein controlling the second polarization controller comprises controlling the third phase shifter and the fourth phase shifter.

5. The photonic system of claim 3, wherein the first interferometer comprises a Mach Zehnder interferometer (MZI) having at least one stage, and wherein the first detector is coupled to a port of the MZI.

6. The photonic system of claim 3, wherein the first polarization controller further comprises a polarization splitter and rotator coupled between the first phase shifter and the unidirectional optical channel.

7. The photonic system of claim 1, further comprising photonic circuitry formed on the first PIC and configured to convey light to the second PIC through the unidirectional optical channel, wherein controlling the first and second polarization controllers comprises controlling the first and second polarization controllers to maximize the first signal.

8. The photonic system of claim 7, wherein controlling the first and second polarization controllers further comprises controlling the first and second polarization controllers to minimize the second signal.

9. The photonic system of claim 1, wherein the first polarization controller comprises a first phase shifter and the second polarization controller comprises a second phase shifter, wherein controlling the first polarization controller comprises controlling the first phase shifter and controlling the second polarization controller comprises controlling the second phase shifter.

10. The photonic system of claim 9, further comprising photonic circuitry formed on the first PIC and configured to convey light to the second PIC through the unidirectional optical channel, wherein controlling the first and second polarization controllers comprises controlling the first and second phase shifters to maximize the first signal.

11. The photonic system of claim 10, wherein controlling the first and second polarization controllers further comprises controlling the first and second phase shifters to minimize the second signal.

12. The photonic system of claim 1, further comprising a substrate, wherein the first and second PICs are disposed on the substrate.

13. A photonic system, comprising:
a laser;
a first polarization controller coupled to the laser, the first polarization controller comprising:
a first phase shifter;
a Mach Zehnder interferometer (MZI), coupled to the first phase shifter, comprising a second phase shifter; and
a first detector coupled to the first MZI;
a unidirectional optical channel coupled to the first polarization controller;
a second polarization controller coupled to the unidirectional optical channel, the second polarization controller comprising:
a third phase shifter;
a second MZI, coupled to the third phase shifter, comprising a fourth phase shifter; and
a second detector coupled to the second MZI; and
a controller configured to control the first, second, third and fourth phase shifters using a first signal provided by the first detector and a second signal provided by the second detector.

14. The photonic system of claim 13, further comprising a substrate, a first photonic integrated circuit (PIC) and a second PIC, wherein:
the laser, the first PIC and the second PIC are disposed on the substrate, and
the first PIC comprises the first polarization controller and the second PIC comprises the second polarization controller.

15. The photonic system of claim 13, wherein controlling the first, second, third and fourth phase shifters using the first and second signals comprises controlling the first, second, third and fourth phase shifters to maximize the first signal.

16. The photonic system of claim 15, wherein controlling the first, second, third and fourth phase shifters using the first and second signals further comprises controlling the first, second, third and fourth phase shifters to minimize the second signal.

17. A method for controlling a photonic system, comprising:
controlling photonic circuitry formed on a first photonic integrated circuit (PIC) to convey light to a second PIC through a unidirectional optical channel coupling the first PIC to the second PIC; and
controlling a first polarization controller, formed on the first PIC, and a second polarization controller, formed on the second PIC, using a first signal provided by a first detector, formed on the first PIC, and a second signal provided by a second detector, formed on the second PIC.

18. The method of claim 17, wherein:
the first polarization controller comprises a first phase shifter and a first interferometer comprising a second phase shifter, and the second polarization controller comprises a third phase shifter and a second interferometer comprising a fourth phase shifter,
controlling the first polarization controller comprises controlling the first phase shifter and the second phase shifter, and
controlling the second polarization controller comprises controlling the third phase shifter and the fourth phase shifter.

19. The method of claim 18, wherein controlling the first, second, third and fourth phase shifters comprises controlling the first, second, third and fourth phase shifters to maximize the first signal.

20. The method of claim 19, wherein controlling the first, second, third and fourth phase shifters comprises controlling the first, second, third and fourth phase shifters to minimize the second signal.
